(19) United States
(12) Patent Application Publication
(10) Pub. No.: US 2015/0142726 A1
(43) Pub. Date: May 21, 2015

(54) System and Method for Decision Driven Business Performance Management

(71) Applicant: James Taylor, Palo Alto, CA (US)

(72) Inventor: James Taylor, Palo Alto, CA (US)

(73) Assignee: Decision Management Solutions, Palo Alto, CA (US)

(21) Appl. No.: 14/522,256

(22) Filed: Oct. 23, 2014

Related U.S. Application Data
(63) Continuation of application No. 13/631,910, filed on Sep. 29, 2012, now abandoned.
(60) Provisional application No. 61/540,793, filed on Sep. 29, 2011.

(51) Int. Cl. G06F 17/30

(52) U.S. Cl. CPC G06F 17/30592
USPC 707/603

(57) ABSTRACT

A decision-driven performance management system comprises storing a decision dependency model in a decision dependency repository, the model identifying relationships and dependencies among sub-decisions, information sources and knowledge elements that form a decision and impact a performance measure of an organization. An extended dashboard and decision space enables a user to use the model to visualize and drill down into decisions and implementation artifacts underlying the performance measure, and to edit these elements to change the performance measure.

### CROSS REFERENCE TO RELATED APPLICATIONS

This application is a continuation of U.S. application Ser. No. 13/631,910, filed Sep. 29, 2012, and claims the benefit of U.S. application Ser. No. 61/540,793, filed Sep. 29, 2011.

### BACKGROUND

Computer systems are extensively used in business enterprises for process workflow, data management and reporting. Systems designed to handle reporting on data (“analytic” systems) are typically separated from systems designed to handle online transaction processing or OLTP systems. Within analytic systems there is a separation between systems designed for reporting on and querying data (often called “business intelligence” systems) and systems for tracking organization performance (“performance management” systems). Within OLTP systems different components or “tiers” typically handle different aspects of the systems with data management, workflow and user interface each being put into their own tiers for easier management.

Both kinds of system need to deal with decision-making. OLTP systems must increasingly make decisions if they are to correctly process transactions and complete their workflow. For instance, without a decision about the validity of an invoice, an OLTP system cannot process that invoice. OLTP systems have historically relied on human beings for this decision-making but with the increasing speed of business and the need for real-time electronic interactions, intelligent rules-based automated decision-making processing capability is increasingly being added to OLTP systems. This decision-making processing is typically implemented as business rules management systems, optimization engines or solvers, and predictive analytic model deployment or in-database analytic engines.

Analytic systems are also increasingly used in decision-making. For instance, analytic systems such as business intelligence or query and reporting systems may provide information and reports, but are mostly concerned with presenting information to a human decision-maker to enable making a good decision. Performance management systems can show managers how well they are doing against their objectives and performance measures, which is helpful to enable management decisions about how to change the behavior of the organization to improve results or to correct problems identified.

What these systems have in common is that they are designed to improve the organization's performance. Of particular utility are dashboards generated by a variety of business performance management and business intelligence software products. A dashboard affords a user interface that organizes and presents information in a way that is easy to read and interpret. The information may comprise reports or graphical components presented through software such as a browser or mobile device application. The reports and graphical displays are often independent, developed by standalone software modules, but may also be linked so that items selected in one such software module affect the behavior of others.

The specific content of each software module is determined by a combination of design information and data. The design information is specified by the organization as part of configuring the user interface while the data comes from operational data sources like operational database systems, existing data warehouses and/or other kinds of data storage such as so-called “Big Data” platforms. Many such software modules are interactive, enabling users to obtain additional information to better understand the data being displayed. For instance a software module showing a graph of sales by month might enable a user to select a particular month and drill down into a report of sales in that month or into a different graphical representation showing how sales in that month were distributed by product line or region. Software modules may enable a user to drill down all the way to the underlying transaction, the most granular element of data.

However, the ability to drill into data does not describe what decisions resulted in the data captured in these various systems, tools and user interfaces. For instance on a display presenting information about operating margin, drilling down into regions, offices, individual sales people and ultimately orders placed may give a sense of what the operating margin is at each level. But, it will not explain why that is the operating margin.

To understand why this operating margin is the way it is, it is necessary to understand how the price and discount were calculated for each order, and how that combined with the margin for specific products to create the overall results. Without an understanding of the decisions that were made about, for example, the pricing of a product for a specific customer, the volume discount on each order, or what to charge for rush orders and shipping, it is not possible to understand the “why”. The decisions made explain the resulting data. To improve results, organizations must know and understand the reasons for the decisions in order to improve them. However, this information is generally not readily available, particularly in large enterprises where there may be many different factors, policies and groups that underlie a decision. Even collecting the appropriate information in such enterprises to permit an understanding of the various and disparate reasons for a decision is a complex and difficult task, particularly when the factors underlying a decision may have diverse and seemingly unrelated connections.

The way decisions are made makes a difference to business performance. If many of the decisions to approve insurance claims, for instance, are made poorly, the insurance company's business performance will suffer. A team can document exactly how the decision impacts business performance by linking the decisions it is defining to the key performance indicators and other performance measures or objectives used by the organization to track its business performance. Most organizations have many such measures, and each decision will impact some of them to a greater or lesser degree. For example, the team may document that a claim approval decision has an impact on loss ratio. Some decisions may have a limited influence, impacting only one measure, while others will impact many. Some decisions may have a small impact on a performance measure, others will have a very significant impact. This too can be documented. However, obtaining access to all of the relevant decisions that impact a performance measure is typically not possible.

Different parts of the organization may be responsible for defining how the decisions should be made, some for following the defined approach and actually making decisions and others simply want to know how the decisions were made, perhaps so they can audit or otherwise monitor the decisions. If relationships among groups responsible for a decision were explicitly documented, this would allow the team to see which organizations play a role in each decision. For example the claims adjustor groups within the insurance company might be identified as the organizations that make the decision to approve the claim, while the head of claims might be identified as the definer of the decision; and the underwriting group might care how the decision is being made so they can reflect this decision-making approach in the policies they write.

Current decision management approaches generate reports and other visual information for business users to interpret in the hope that they will be able to improve the decisions being made. However, it can be difficult for business users to know what actions are needed to improve results based simply upon the information presented due to a lack of visibility into the decision-making process and the background of that process that resulted in the data. For an action to make a significant difference in future results, it must change the way the organization behaves. For most organizations, this means changing the behavior of OLTP systems by altering the decision-making tier of those systems. This means that the user must change the organization's pricing or discounting approaches as implemented in the system decision-making tier to improve its operating margin. Even if needed changes are able to be identified correctly, lead times for system and process changes can result in delays in corrective action, at real cost to the organization. With a dashboard or other similar user interfaces, the only way such a change can typically be made is to contact those in the organization who can change the behavior of existing information systems, such as the IT group, or those in business units whose teams make these decisions. This is at best an imprecise and slow process.

What is needed, therefore, is a method and system for linking relevant information as to how an organization has implemented decision-making in its operational environment in an automated decision-making tier of its OLTP systems, for instance, and for affording insight and understanding into the decision process by providing the reasons for decisions, so that these are available in performance management systems.

### SUMMARY OF THE INVENTION

The invention addresses the foregoing and other problems in managing business decisions that impact performance in an effective and efficient manner, by affording a system and method that enable an organization to create a decision dependency model that defines the dependencies and relationships underlying organizational decisions and provides insight into the reasons behind decisions so that the organization is better positioned to adjust decision making processes to address issues.

The invention provides a decision-driven management system and method for managing the performance of an organization. It employs a dashboard that identifies and displays information about the elements that affect a performance measure of an organization, and that allows the elements to be managed and changed. The dashboard obtains information from a decision dependency model in a decision dependency repository, identifies the relationships and dependencies among the elements that relate to decisions that affect a performance measure of the organization, and obtains additional information from another repository about elements that impact performance. The dashboard identifies the elements for which additional information is available, and provides access to the additional information in-situ or through a decision space in which the additional information is presented to a user. The dashboard enables relevant information from the repositories to be overlaid for presentation. The decision space allows the relevant elements to be managed and changed using the dashboard to manage performance. An authoring module links to the elements in the decision dependency repository, and allows the element affecting performance to be changed.

The model indicates the dependencies of the decisions involved on each other, on information used in the organization, and on knowledge about decision-making so that it is clear how the organization makes the decisions. The model includes dependencies of decisions on the overall organization and on its objectives and performance measures as well as on the contexts in which decisions must be made such as the business processes and systems that run the organization's day to day business. The model also includes dependencies to the implementation of those decisions in automated knowledge-based processing systems such as business rules management systems, optimization suites or solvers, data mining or predictive analytic systems and in-database analytic engines. The invention by correlating decisions to their relationships and dependencies affords knowledge as to the organizational policies and reasons underlying decisions, and provides insight into how to implement changes in decision-making systems to accomplish organizational objectives.

### BRIEF DESCRIPTION OF THE DRAWINGS

FIGS. 1A and 1B are block diagrams illustrating elements of an embodiment of the invention, and their interactions with each other and with external systems;

FIG. 2 is a flow chart illustrating an embodiment of a process in accordance with the invention of building a decision dependency model;

FIG. 3 is a flow chart illustrating a process of using a decision-centric dashboard in accordance with the invention for performance management;

FIG. 4 shows relationships among information elements that may define a decision dependency model in accordance with the invention for defining the business context of a decision;

FIG. 5 shows relationships among information elements that may define the implementation context of a decision dependency model;

FIG. 6 shows an example of the decision dependency model for representing a business decision;

FIG. 7 shows an example of editing the decision dependency model of FIG. 6;

FIG. 8, comprising FIGS. 8A and 8B, shows a process for entering additional information about elements of a decision;

FIG. 9 shows an example of a dashboard being altered in accordance with the invention;

FIG. 10 shows an example display of a decision space in accordance with the invention;

FIG. 11 shows a process for identifying dashboard components with additional information available;

FIG. 12 shows a process for displaying additional information in-situ on a dashboard; and

FIGS. 13A and 13B, show a process for displaying decision space information to a user.

### DESCRIPTION OF PREFERRED EMBODIMENTS

Organizations make many decisions. Some of these decisions are one-off strategic decisions, such as deciding whether to do business in a particular country. Others are repeatable decisions that the organization or business takes more than once. For example a bank makes loan approval decisions every time someone applies for a loan; a telecommunication company makes a decision to select a particular retention offer every time a customer calls to cancel their service; and an insurance company makes a decision to pay, reject or refer a claim every time one is submitted. The invention is concerned with these repeatable decisions.

All organizations make repeatable decisions. Unlike a one-off decision it is possible for an organization to define, in advance, how it would like to make these decisions. It can define the pieces of the decision, the sub-decisions, the information that must be available to make the decision and the know-how required to make the decision. The information required might be data collected and managed by the organization or be data available from outside the organization. The know-how for a decision might be published company policies, government regulations, best practices or tribal knowledge known to employees or the results of historical data analysis to see what had worked best in the past. The invention takes advantage of this fact by allowing the analysts and business managers in an organization to create a model of each of the repeatable decisions in their business. The model defines the sub-decisions, information requirements, and know-how used in a decision. It affords insight into the factors involved in a decision, which facilitates changing the basis for a decision to address problems and issues that arise.

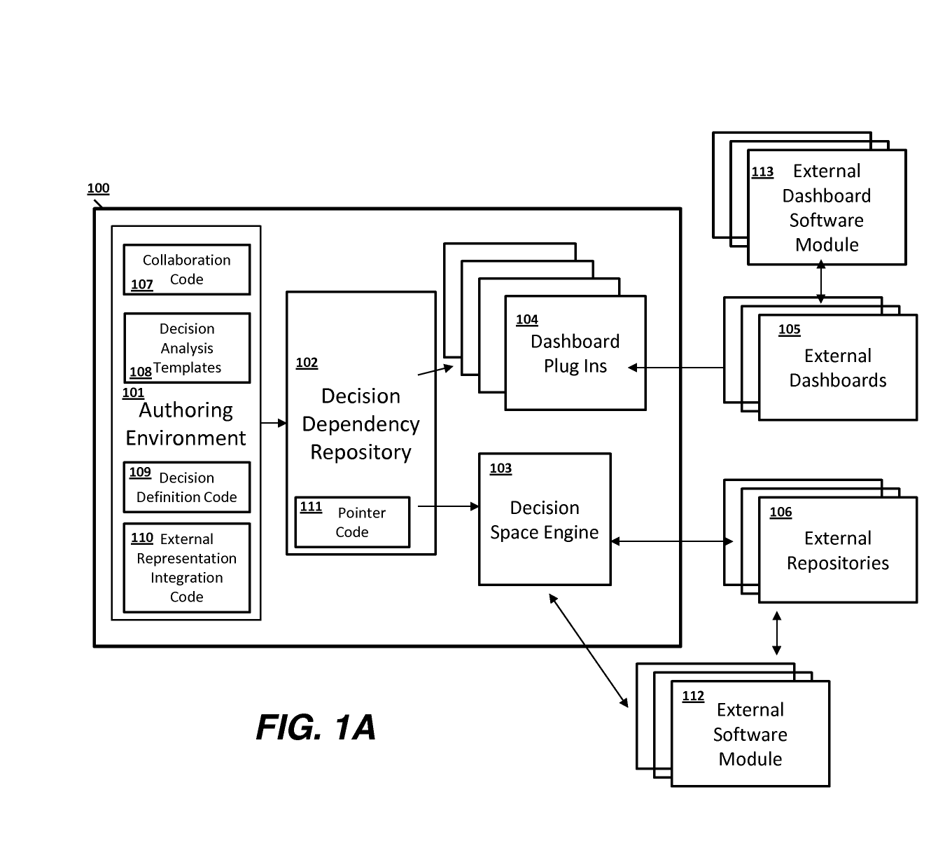

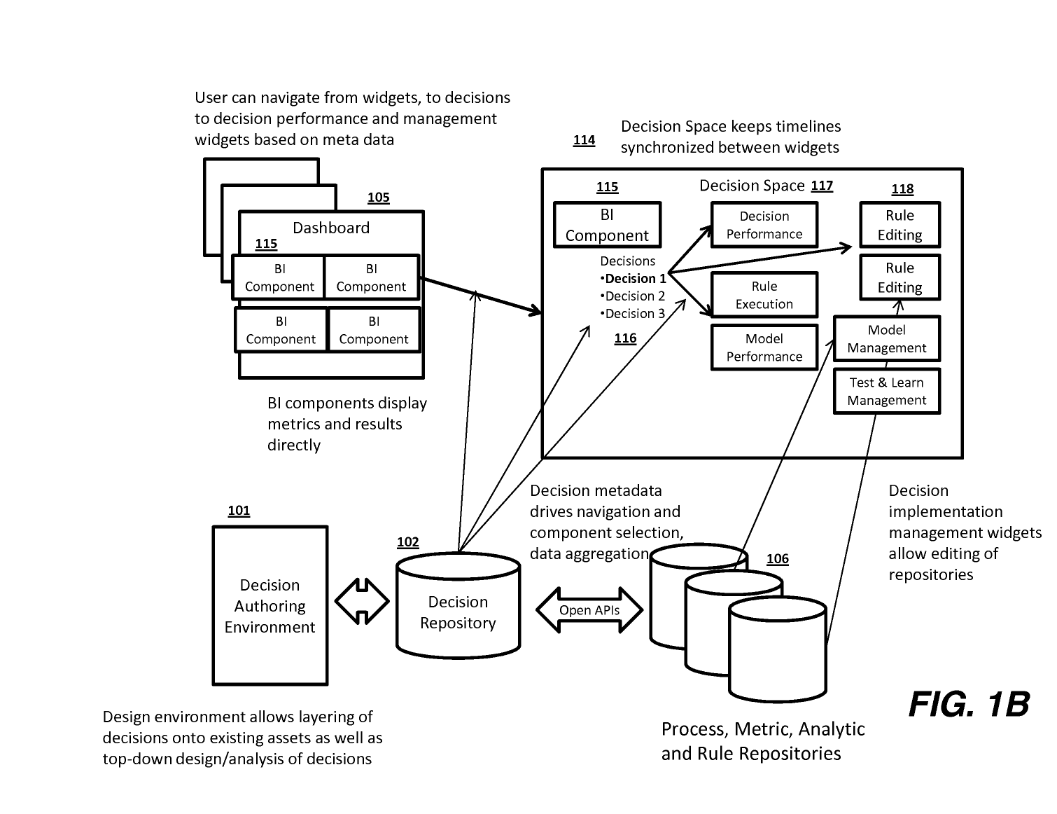

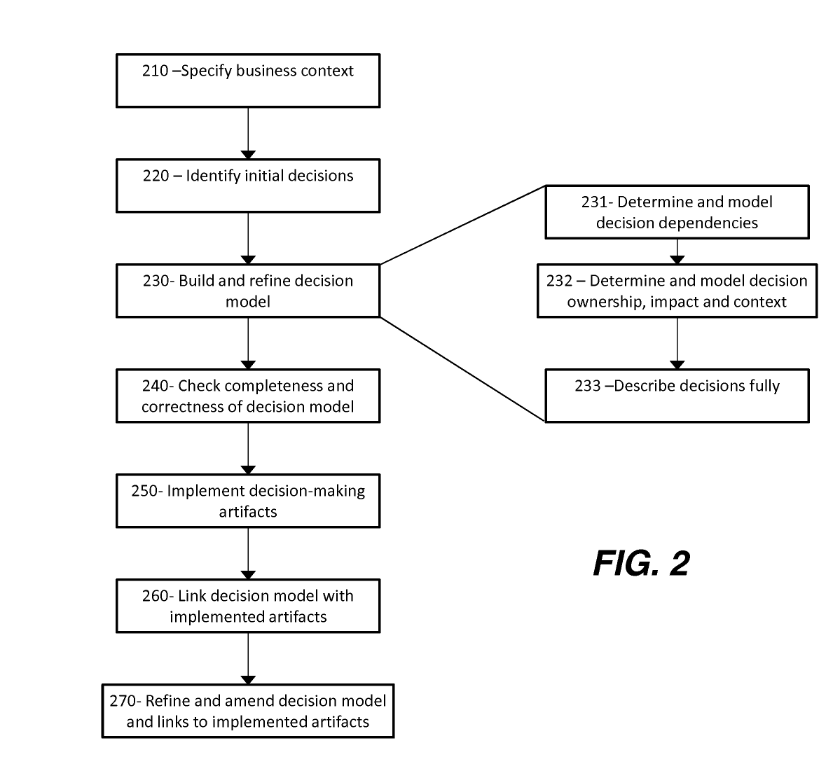

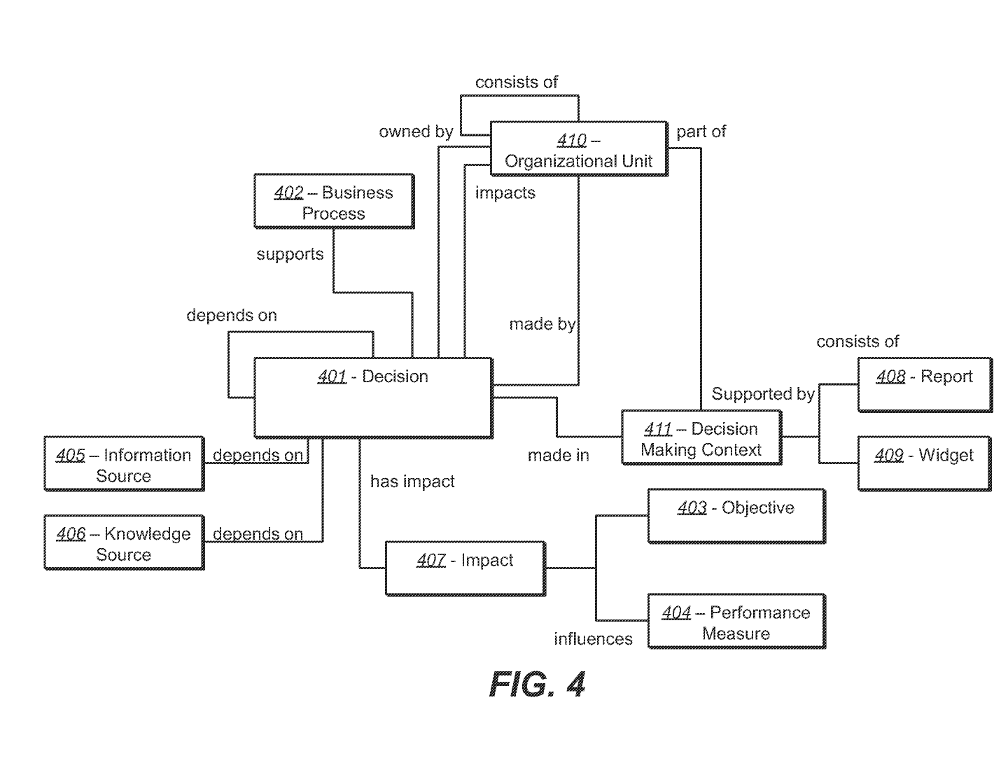

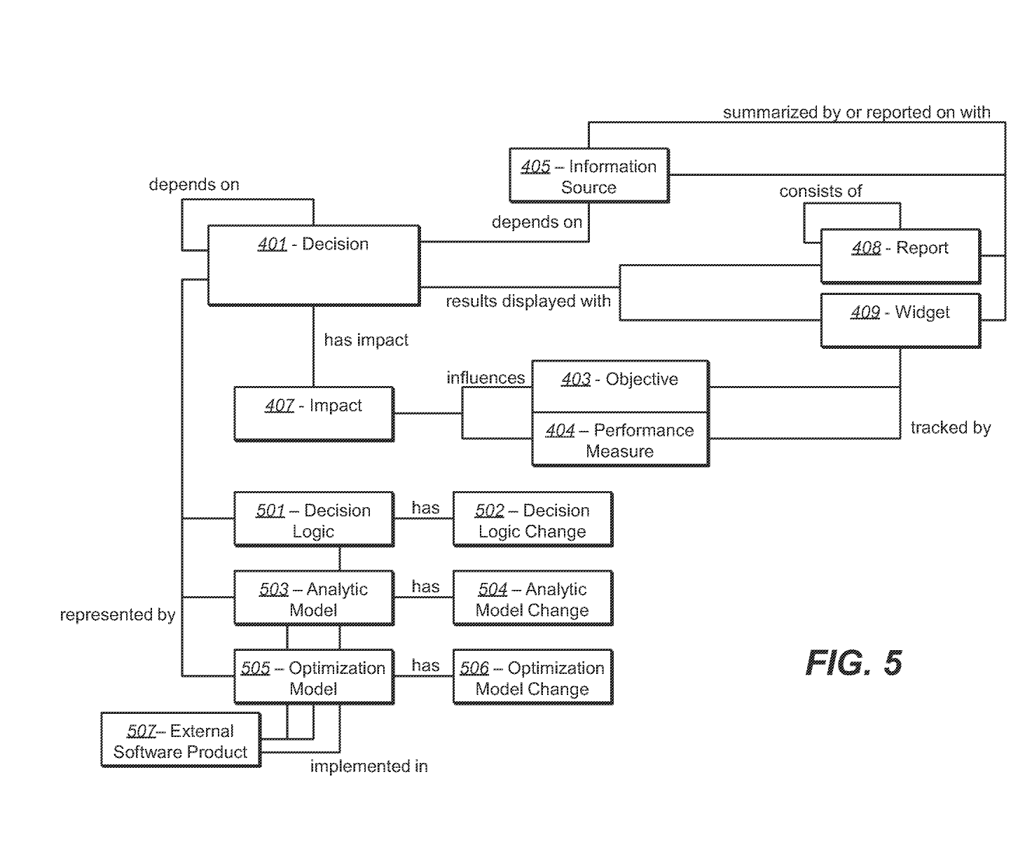

Using the system shown in FIGS. 1A-1B, especially the authoring environment 101, and the process outlined in FIG. 2, a group of business users can create a decision dependency model and store it in a decision dependency repository 102. The model includes the information such as shown in FIGS. 4 and 5, about decisions, about the information used in these decisions, and the knowledge and policies used to make these decisions. The information stored in the decision dependency model repository can be used by software modules 112 external to the repository to create implementation artifacts (instructions) that enable the organization's systems to make decisions or recommend decision outcomes. The definitions of these artifacts may be stored in repositories 106 external to repository 102.

The authoring environment 101 enables the contents of the repository to be refined, extended and linked to other information already in the repository and to information describing the implementation artifacts in the external repositories. Information such as that described in FIG. 5 and pointer code 111 may be used to describe the links between the logical decision dependency model created earlier and the definition of its implementation. The pointer code 111 may also be used to link the decision model to the external software modules. Organizations typically display the state or history of a business performance measure or key performance indicator (KPI) on one or more dashboard components. Several such components 115 may be grouped into a page or similar output and presented to a user as part of a dashboard 105 to allow them to review and assess performance. By connecting to an external dashboard software module 113 that manages these components, the decision repository can be enhanced to show which dashboard components correspond to which measures or objectives. For example, a team documenting relationships in a claim processing process using the authoring environment might determine that loss ratio may be displayed using several components, one showing change on a month earlier while others show loss ratio over time and loss ratio against targets.

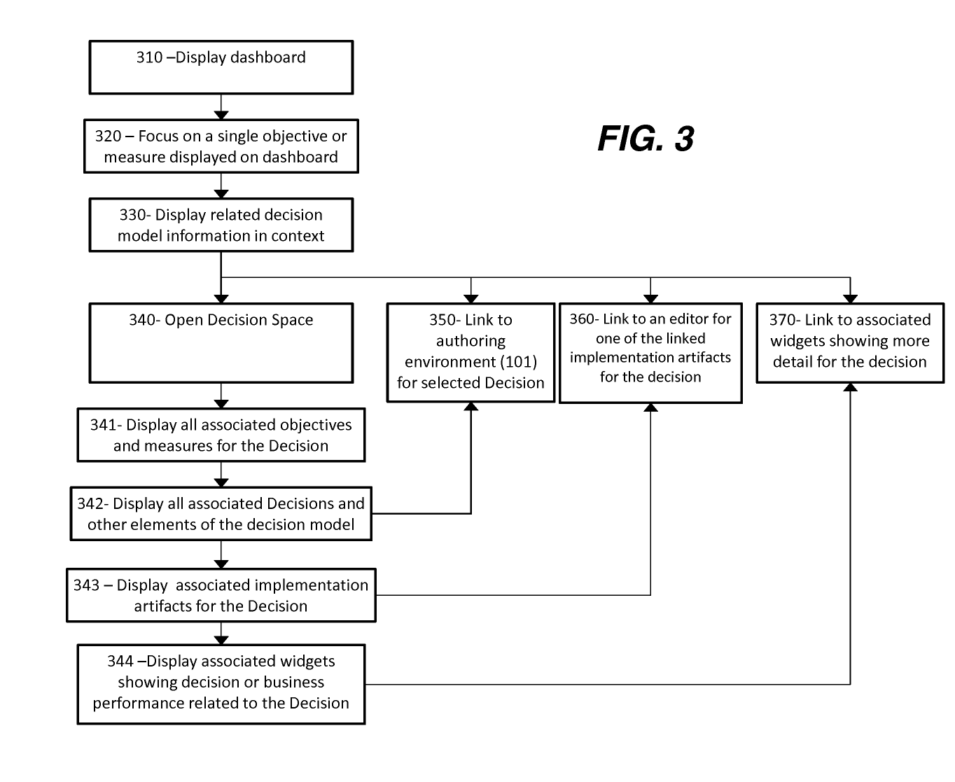

Once the decision dependency repository is populated for a given business area, the invention enables external dashboards 105 to present information about the performance of the business such as, but not limited to, information about progress towards business objectives and the current value of defined performance measures such that users can now see and interact with additional information about their business and how it makes decisions. The overall process for this is described in FIG. 3.

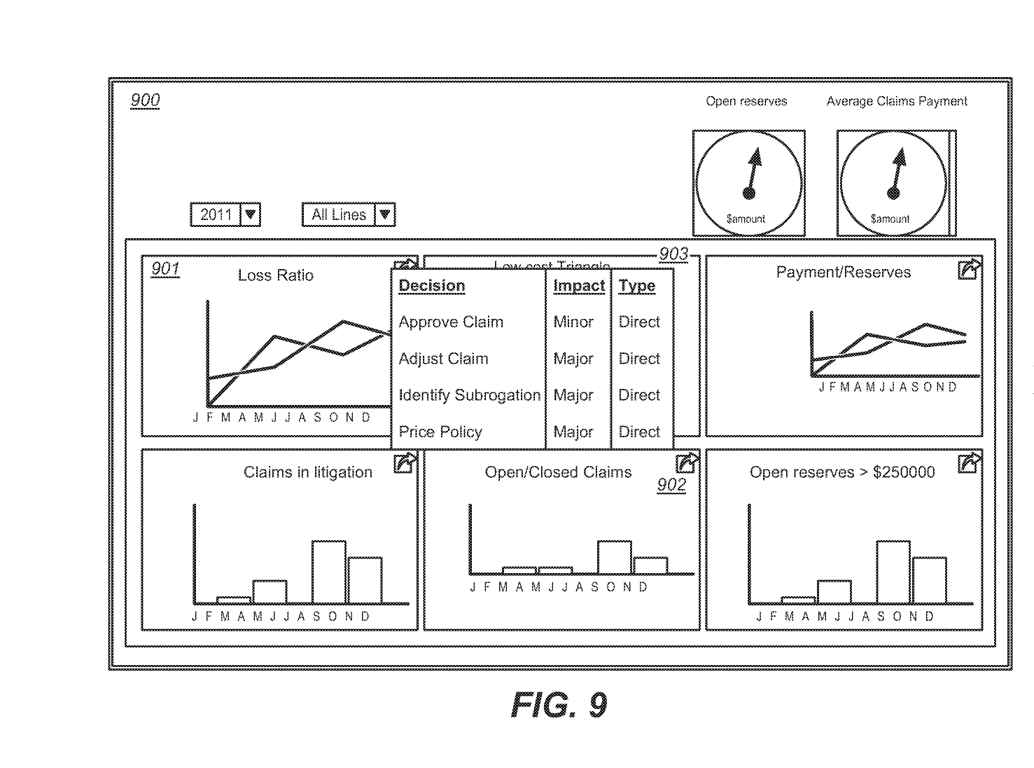

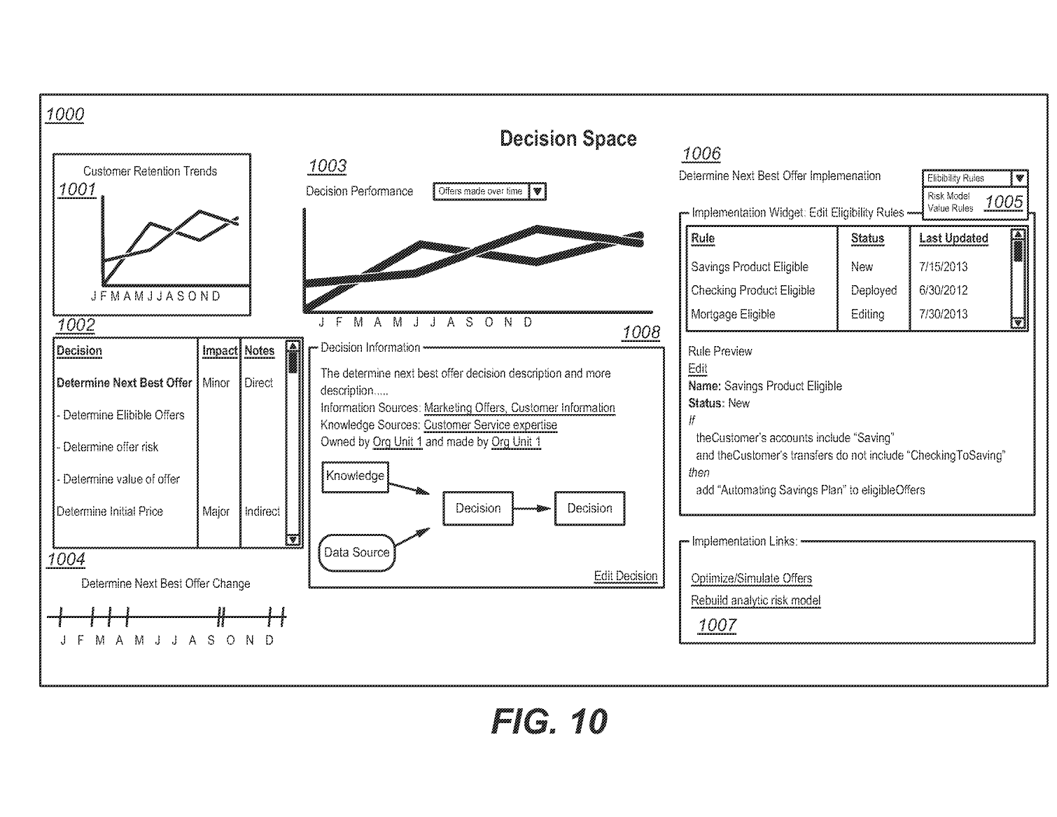

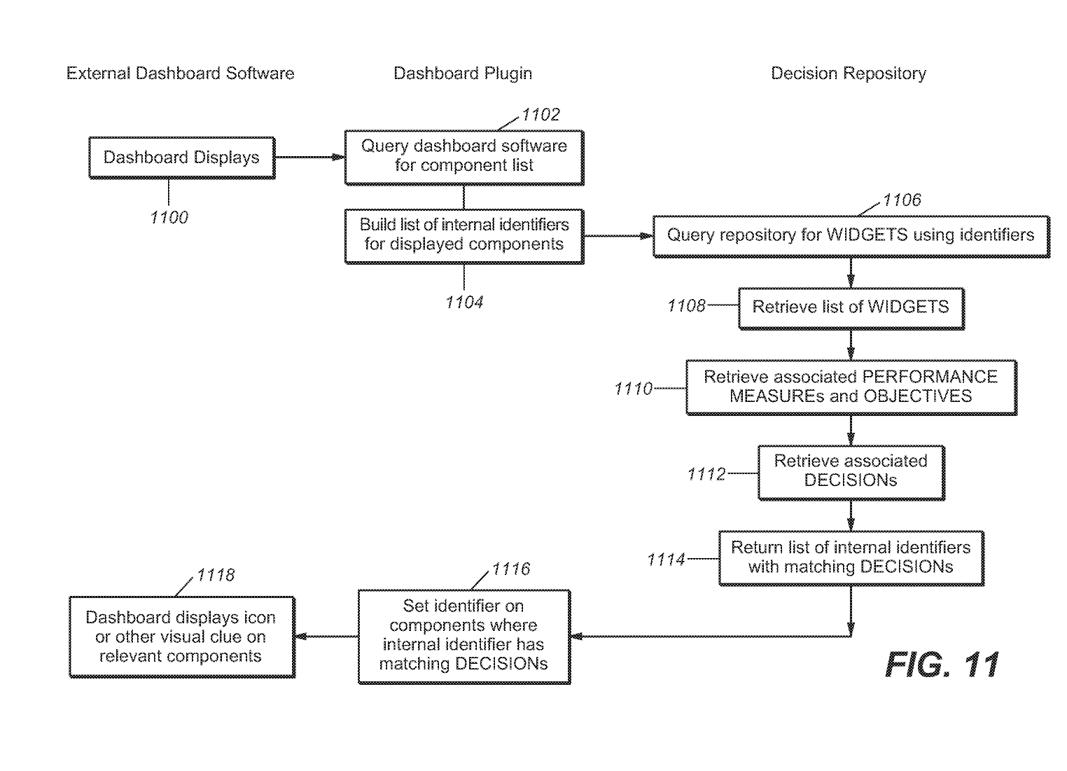

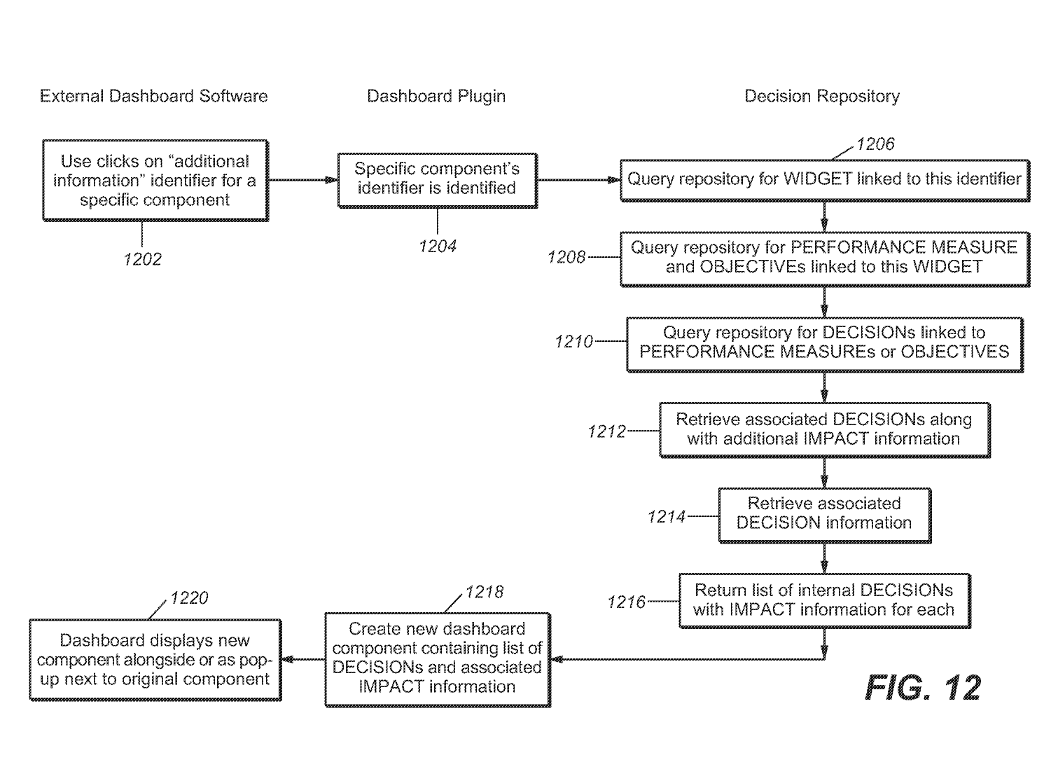

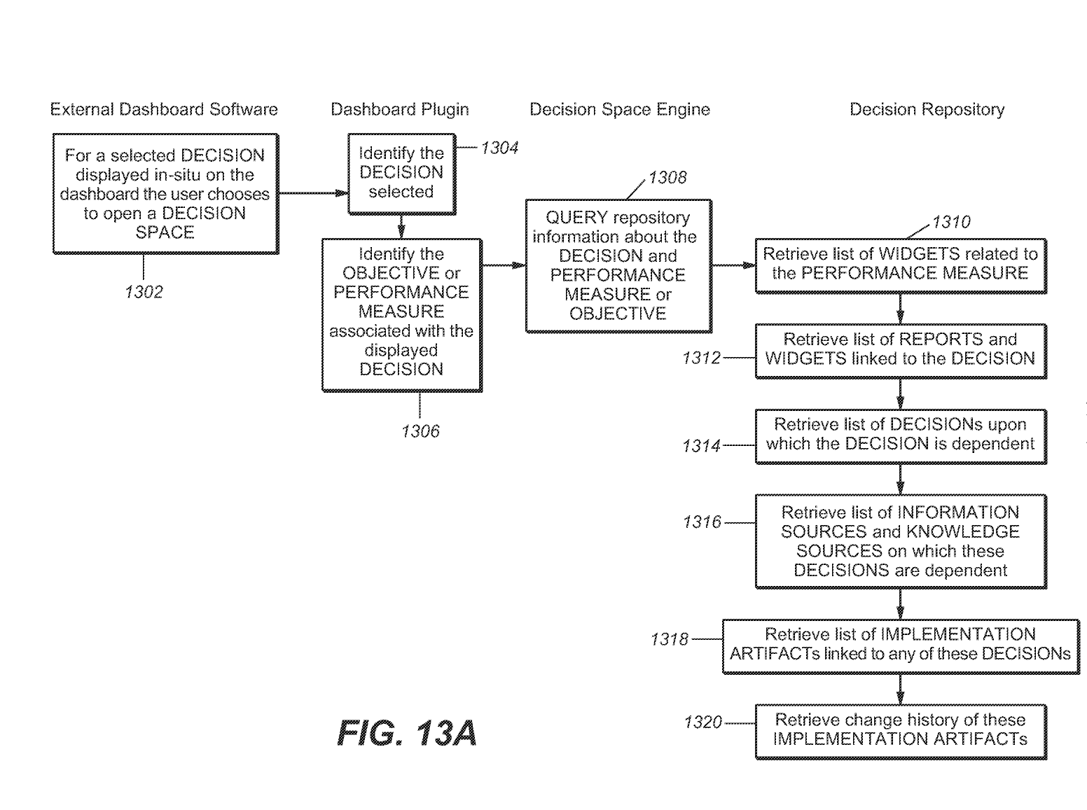

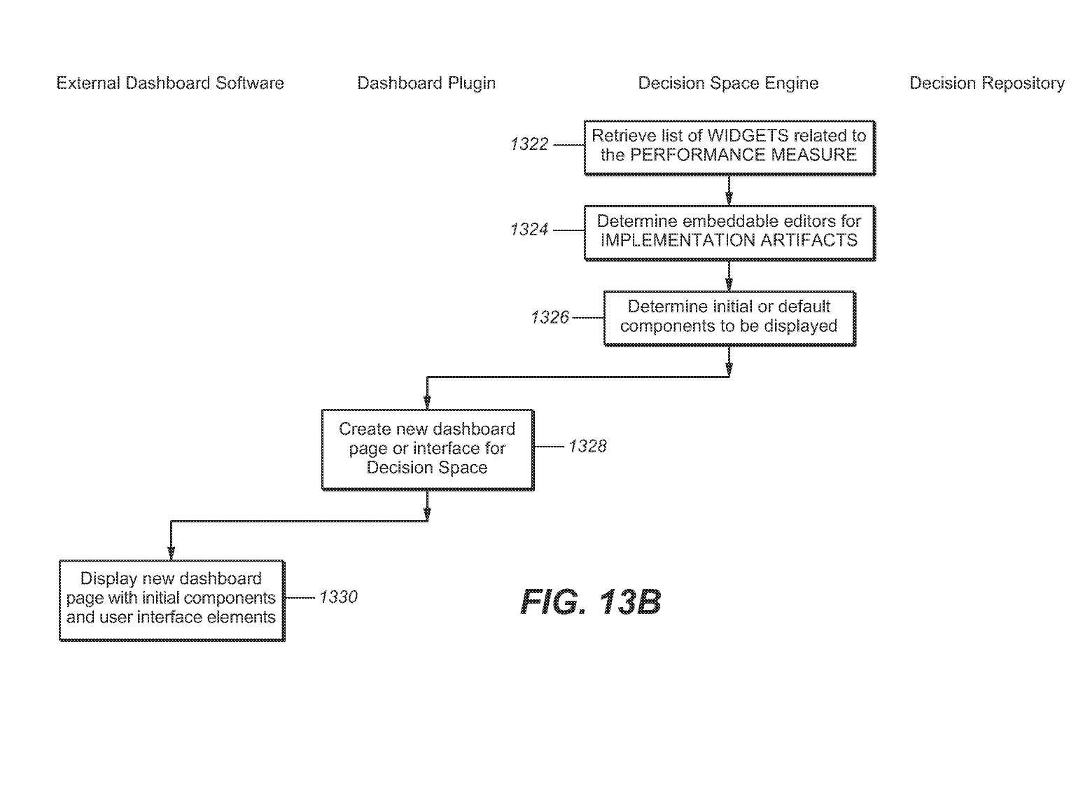

Once a dashboard 105 is displayed, the process shown in FIG. 11 identifies the elements of the dashboard for which additional information is available in the decision dependency repository. As users focus on a specific objective or performance measure displayed in a component 115 of the dashboard 105 (FIG. 1B), they can use standard features of the dashboard and the capabilities of the invention embodied in the corresponding dashboard plug-in 104 to display in-situ additional information such as shown in FIG. 9. The process described in FIG. 12 may be used to identify the correct information to display in situ. The business user can navigate to the authoring environment 101 or an editor for a linked implementation artifact 118 or to other components displaying additional relevant information 117 using the links defined in the decision dependency model repository. The user may also open a decision space 114, as shown in FIG. 10, by the process outlined in FIG. 13. The user can navigate from the decision space to the authoring environment 101, an editor for a linked implementation artifact 118, or to other components displaying additional relevant information 117 using the links defined in the decision dependency repository.

The invention enables a business user to drill down from displayed business results into the business decision-making process to improve understanding of business performance, which enables business people to take more direct action to address issues. A system in accordance with the invention links business performance information presented in a user interface, such as a dashboard, to the underlying definitions and reasons as to how and why decisions are made. When the results presented are not what a business user wants, the user is able to navigate directly to the definition of the decision-making approach being used and to the implementation artifacts that embody that decision-making approach in software in an automated processing system. The user can change the organization's decision-making approach so that future decisions are made more effectively leading to better results.

FIGS. 1A and 1B are block diagrams of a computer system 100 in accordance with the invention. In addition to standard system components, the system 100 may comprise four main components: an authoring environment module 101, a decision repository 102, a decision space engine 103, and dashboard plug-ins 104, which are described in the following.

The authoring environment 101 may comprise executable instructions embodied on non-transitory computer readable media for controlling the computer system to enable business users to collaborate, analyze and capture information about decisions and generate external representations of the decisions. The authoring environment enables layering of decisions onto existing information assets as well as top-down design and analysis. It may be used to create or change a decision dependency model. The decision repository 102 may comprise storage that stores the information created in the authoring environment, which the system may automatically link to other repositories 106 to make it available for other applications to use. The decision space engine 103 comprises a processor that may generate a portal or other information presentation environment which may use the information in the decision repository to link to external software modules 112. The dashboard plug-ins 104 may comprise user interface software for external dashboards 105 generated by software modules 113, or other user interfaces, to enable the information in the decision repository to be presented in the context of a user interface and navigation to an appropriate decision space.

The authoring environment module 101 may comprise several software code (executable instruction) modules including collaboration code 107 that provides a collaborative workflow environment (such as a social environment) for users to define decisions and the relationships of the decisions to other elements of the business. This environment enables comments and collaboration so that the definitions of decisions and other objects in the decision repository may contain a history of the discussions and editing that gave rise to formal definitions and properties.

Another decision definition code module 109 enables business, analytics and IT people to define the business decisions and their relationships that control the operation of automated decision-making systems. The module may include, for example:

Decisions, their properties and their decomposition into more fine-grained decisions;

Dependencies of decisions on know-how and information;

Organizational structures and the decisions they own, use and are impacted by;

The relationships of decisions to the organization's objectives and measures, including information on how direct and significant that relationship;

The relationships of decisions to artifacts created using decision-making technologies, including rule sets and decision flows created in business rules management systems, predictive analytic models created in modeling workbenches, reports created in business intelligence tools, and optimization models;

The availability of software modules that report on different aspects of a decision such as its execution volume and distribution of decision outcomes;

The availability of software modules that report on objectives and KPIs; and

Events that seemed significant to objectives or decisions.

Another software code module 108 may provide decision analysis templates that assess the completeness and correctness of the decision definitions and their relationships to external objects. These templates ensure correctness, e.g., by ensuring that decision dependency networks remain acyclic. They may report on completeness, e.g., that all decisions are linked to objectives and identify those objects whose definition and relationships do not appear to be complete, such as those decisions that lack defined questions and answers (properties of the decision object) or that do not have implementation components linked to every dependent decision. The analysis templates may help the organization to verify and validate a model.

A further software code module 110 may be external representation integration code that enables creation and management of references to objects stored in the external repositories 106, such as but not limited to systems such as a business rules management system repository, predictive analytic models in a modeling repository, reports defined in a business intelligence (BI) definition database, performance management or dashboard definitions, etc.

The decision dependency repository 102 may contain the information created and maintained by the users of the authoring environment 101. It may comprise pointer code 111 that contains pointers to object instances stored in other external repositories 106. Each pointer preferably may contain some human readable information, such as the name given the object in the other repository and its location in the repository, as well as machine readable information such as the internal identifier of the object. The human readable information enables users to navigate this information, while the machine readable information enables links to be maintained even if names or properties are changed in the other repository. The decision dependency repository system may maintain these pointers automatically using the published APIs of those systems and agent technology, as needed, to enable the decision dependency repository to be updated with new or changed information when the various systems change even if those systems are behind firewalls. Once a link is defined that describes what information should be pointed to in a particular external repository, an agent can be generated to monitor the external repository for changes and then push those changes to the decision dependency repository to keep it up to date.

Information about such as business processes, business rules, predictive analytic models, and business performance metrics may be managed in the external repositories 106. The system does not modify or change information in the external repositories.

A dashboard plug-in 104 may be generated for each external dashboard software 113 module used to create external dashboards 105 or other user interface environment supported, such as for example Cognos, BusinessObjects, and SQL Server BI. A plug-in using a process such as described in FIG. 11 preferably:

Identifies each software module currently displayed;

Queries the decision repository to see if the software module is linked to a specific decision;

Queries the decision repository to see if the software module is linked to a specific objective or KPI that is in turn linked to specific decisions; and

For each software module with some decisions identified, highlights the software module in some unique way, such as my displaying a decision icon alongside the software module.

The user may use this change in display style to display in situ a list of associated decisions as well as information about the relationship of a decision to the software module being display, e.g., “Decision 1: Outcomes” or “Decision 2: Significant, direct impact” using a process such as that described in FIG. 12. For instance, the user may click an icon or a trigger of software module could be activated in some pre-defined way. The user may interact with the list in multiple ways, such as, for instance, by viewing information about the decision (the description pulled from the repository for instance); navigating to the authoring environment to review or edit the decision; expanding the decision to see the decisions on which it is dependent and their relationship (if any) to the currently selected software module; or opening a decision space for a decision/objective combination.

The external dashboards 105 managed by the external dashboard software modules 113 may typically display one of more BI components 115 (FIG. 1B) that present, summarize or analyze information about the business of the organization.

The decision space engine 103 may generate a portal or other information presentation environment that uses the information in the decision dependency repository 102 to link to external software modules 112. This information presentation environment is called the decision space 114.

The decision space engine 103 may use the information in the decision dependency repository 102, an external dashboard 105, and performance management software as well as decision-making technologies, such as but not limited to business rules management systems, predictive analytic workbenches and reporting tools, to enable their user interface to be displayed by software module 112 as part of a composite work environment. The decision spaces are further described in FIG. 3.

The decision space 114 may contains a number of components including BI components 115 such as those displayed on the dashboards 105, information 116 about a decision and its dependency network, components displaying information about decision performance 117 such as the percentage of transactions handled by an automated decision, the distribution of decision outcomes for a given decision, the business rules executed to make decisions or the performance of analytic models used in decisions. Other components may allow the editing of implementation artifacts 118 such as business rule editors, analytic model management interfaces or links to same. The decision space 114 coordinates these components to keep information displayed on them synchronized so that, for instance, a change in date range being viewed on one component is reflected in other components, or so that a change in the decision selected changes the information displayed in a decision performance component.

FIG. 2 illustrates a process that may be followed by a user to populate the decision dependency repository 102. An initial business context may be specified (210) comprising information such as the high-level business processes (402) and organizational structures (410), explained in more detail in connection with FIG. 4. Business objectives (403) and performance measures (404) of the organization may also be defined. The business user may then identify (at 220) the initial set of decisions (401) required for the business context. These decisions are associated with the business processes and objectives/performance measures that they support and with the organizational units that own or make them.

An initial decision model is refined at 230. This may comprise determining and modeling the decision dependencies (231-233) between the initial decisions (401) and other decisions, information sources (405) and knowledge sources (406). This process is iterative, with each new decision identified being refined and modeled in its turn. Each decision found may be assessed to determine which organizational unit(s) define how it is made, which organizational unit(s) make the decision day-to-day, which specific tasks in the business processes execute the decision making, and which business objectives and performance measures it impacts. Each decision may be also fully described in terms of how often the decision is made, how complex it is, how easy it is to tell good decisions from poor ones and more. All the additional information found about the organization's decision-making is recorded in the decision dependency model repository.

The model, thus, created can be checked for completeness and correctness at 240 by assessing the consistency of links between objects in the repository and the completeness of property definitions. Thus, for instance, decisions that do not have descriptions or any dependencies on information sources may be flagged as incomplete. Additionally the business user can report on and review the content of the repository to make qualitative judgments regarding its completeness. Once the model is considered complete by the business user, it may be implemented at 250 in external software modules (112) that support decision-making such as business rules management systems, optimization suites or solvers, data mining or predictive analytic workbenches and in-database analytic engines. As this implementation work is completed, the business user can use the authoring environment 101 and pointer code 111 to bring the definitions of these implementation artifacts (such as those shown in FIG. 5) into the repository. Once the pointers to these external repositories have been created, the business user may associate decisions with the implementation artifacts (at 260) used to describe the decision making involved in the decisions. Over time the business user can return to the authoring environment to update the model (270) of decision-making to reflect new approaches being used by the organization, new decisions or decision areas, or to change the links to implementation artifacts as those artifacts are revised and extended.

FIG. 3 illustrates a way that a business user can interact with the system of FIG. 1 in a decision-centric performance management environment. First a user may log in or otherwise display a dashboard at 310 using standard dashboard technology. While using the dashboard software, the user may focus in on a specific business objective or performance measure displayed on the dashboard (at 320) for which additional information is available (details on how this may be determined is explained in connection with FIG. 11). The business user may then choose to display additional information in context on the dashboard (330), as explained in connection FIG. 12. This additional information may includes information on the decisions involved in meeting the particular performance objective or improving the particular performance measure. The invention allows this information to be used as the basis to open a decision space (340), link directly (350) to the authoring environment (101) for one of the decisions, link to an editor for one of the linked implementation artifacts (360) or link to an associated component showing additional information about the decision (370). At step 340, additional information may be retrieved (as by using the process described in connection with FIG. 13) that displays as a new page or interface within the dashboard environment. This interface is dynamic, and contains components that display other decisions, performance measures and objectives linked to the decision that is the subject of the decision displayed (342). All the information in the repository (102) for the decision is available in various components, in addition to the implementation artifacts directly or indirectly linked to the decision are displayed (343). This includes information about the timelines of updates to these artifacts based on information stored in the repository as well as links to editing environments for those artifacts and potentially editors for those artifacts embedded in the interface as components where this is possible. Finally the repository is queried to identify additional widgets (objects) or reports that contain information about decision performance and this information is also displayed (344).

Depending on the specific dashboard technology, the user may be able to move the various components around on the user interface, zoom in or out on the various components, display and hide components to focus only on some of the components etc. They may always select a related decision described in the decision space and navigate to a decision space centered on that decision. An example of such a decision space is shown in FIG. 10.

FIGS. 4 and 5 illustrate a data model in accordance with the invention comprising information objects. The information stored in the decision repository and used to drive the decision space engine 103 and the dashboard plug-ins 104 may conform to this data model. All objects in the repository can be commented on and the comment history is persisted. Similarly issues can be raised and managed for any object in the repository. All comments and issues are linked to the user who created them. The creator of any instance of an object in these data models, as well as the author of any change, is also recorded. This enables the engine to show the list of collaborators (everyone who has participated in creating, editing, commenting or raising an issue) for an object as well as allowing users to see the history of an object, its changes and its comments.

FIG. 4 illustrates a decision dependency data model in accordance with the invention for defining the business context of a decision. It shows a plurality of core objects that may be used to define the decisions that an organization makes and how they relate to other aspects of the business and its performance.

A decision object 401 comprises information about a type of business decision that the organization must make more than once, and a definition of how the organization makes or intends to make each decision of this type. Examples are approving a claim that has been submitted, making a marketing offer to a specific customer while they are browsing a website, pricing a car loan or underwriting an insurance policy. A business decision is defined in terms of its name, description, the question it answers and the allowed answers to that question. In addition information about repeatability, volume, measurability, time to value and other information that characterizes the decision may be captured. Decisions can be dependent on other decisions meaning that they cannot be made until and unless the decision on which they are dependent has been made. These associations between decisions are also recorded in the repository. A decision “approve claim” may be dependent on “validate claim”, for example, to show that claims cannot be approved unless they have first been validated.

As shown in FIG. 4, decisions may also depend on other decisions as well as on information sources 405 and knowledge sources 406. That is they cannot be made until the other decisions are made and without access to those information sources and knowledge sources. Decisions support business processes 402 that cannot complete without the decision being made. Decisions are owned by organizational units 410 within the organization that define how the decision should be made, and made by which persons who are members of the same or different organization units. Decisions may also impact other organization units, and may impact on one or more of the objectives and performance measures of the organization. Accordingly, decisions may be part of a decision-making context 411.

A business process object 402 provides information on a sequence of activities or tasks tied together to deliver business value in the organization. The full definition of a business process is generally stored in a different repository, and only a few properties as well as a pointer to the external definition are stored. A business process is executed by the organization to deliver value, e.g., to process claim or underwrite loan. These are often modeled and managed in a business process management system, and business processes may require decisions to be made in order to complete.

Objectives objects 403 comprise information about measurable, achievable milestones or targets towards which the organization is currently working. The full definition of the objective is generally stored in a different repository and only a few properties as well as a pointer to the external definition are stored. These are often monitored using a dashboard or performance management software. Objectives are impacted by decisions.

A performance measure object 404 comprises information about some performance measurement or performance indicator (sometimes called a key performance indicator or KPI) that is tracked by the organization as a way to track its performance. The full definition of the performance measure is generally stored in a different repository and only a few properties as well as a pointer to the external definition is stored. These are often monitored using a dashboard or performance management software. Performance measures are impacted by decisions.

An information source object 405 provides information on a source or collection of information available to the organization that is used when making one or more decisions. An information source might be a collection of documents, a database or log files such as customer contracts, transactions or weblog data, e.g., a claims database or emails sent to a support desk. Decisions can be dependent on these information sources meaning that they cannot be made without access to the information source.

A knowledge source object 406 provides information on a source of knowledge about how the organization must make or desires to make decisions. Examples might include policy documents, regulations, collections of experience or best practice, or analytic insight derived from historical data. Knowledge sources represent policies, regulations, expertise, analytic insight or other forms of knowledge used to make a decision. Decisions are shown to be dependent on such know-how when the know-how is required to make a decision. For instance, an approve claim decision might be dependent on state claims regulations.

An impact object 407 provides information on a discussion of the effect a particular decision has on a particular objective or performance measure. A decision might have a significant, direct impact on an objective if the quality of that decision materially affects the organization's ability to achieve the objective, and might have only an indirect and minor impact on a performance measure if the quality of the decision makes only a small difference in the value of that measure.

A report object 408 may be used by the organization to summarize and present data. The full definition of the report is generally stored in a different repository, and only a few properties as well as a pointer to the external definition may be stored n the decision dependency repository 102. Reports present information about the organization so that decisions can be made. Reports are linked to the decisions that they support. Reports can also be about the performance or history of a decision. Reports may be defined as containing other reports to reflect a hierarchy common in reporting systems.

A widget object 409 provides information on a dashboard component used by the organization to summarize and present data in the context of a dashboard or other user interface. The full definition of the widget is generally stored in a different repository and only a few properties as well as a pointer to the external definition may be stored in the decision dependency repository 102.

An organizational unit object 410 comprises a group, division, department, team or role within the organization. An organizational unit is a team, department, division or other part of an organization. These have a hierarchy (so a Claims Fraud Investigation Unit might be part of the Claims Processing Division, for instance) and can own, be impacted by or make specific decisions. Organizational units may be defined as containing other organizational units to describe an organization structure.

When a decision is made by an organizational unit it implies a decision-making context 411. Such a context can be supported by one or more reports and widgets designed to help those in that organizational unit make that specific decision.

FIG. 5 shows additional information objects in the decision dependency model that may be needed to link the definition of decisions to implementation objects stored in other repositories. All of these objects typically have a history to show when new versions were deployed into production.

Referring to FIG. 5, the decision object 401 may have additional relationships. Decisions can be linked to reports and widgets that display the results and outcomes of decisions, for instance a widget displaying the distribution of offers made to customers. Decisions can be represented by one or more decision logic objects 501, analytic model objects 503, and optimization model objects 505. These may represent a current implementation of the organization's decision-making approach for a decision in external software.

As shown, objective objects 403 may be linked to widgets 409 that are used to track progress and display how the organization is doing in achieving the objective. Performance measure objects 404 can be linked to other widgets 409 that are used to track business performance against the measure so that users of a dashboard can see how they are doing relative to a defined measure. Information source objects 405 can be linked to reports and widgets that are used to present the information stored in a real world store represented by the information source. For instance, a claims database might be represented by an information source, and a number of reports might exist for summarizing claims.

Information about a collection of decision making logic 501 may be represented in external software such as a rule set in a business rules management system or a decision table in a CRM system. Each piece of decision logic can be executed by the external software as a function or a service. Decision logic may be fully described only in the external software's repository and only a summary plus a pointer to the decision logic may be stored here.

Decision logic 501 may be linked to an external software product 507 in which it is being modeled. Decision logic has a set of decision logic changes 502 representing the history of the decision logic in the external software product. Decision logic change information 502 about each change made to a decision logic may be as reported by the repository in which it is stored. Only a summary of the change (user, date, time and any notes) may be stored in the decision dependency repository. Information about an analytic model 503 may be represented in external software, such as a regression model in a predictive analytic workbench or a behavioral segmentation model in a data mining tool. Each analytic model can be executed by the external software as a function or service. Analytic models may be fully described only in the external software's repository and only a summary of a model plus a pointer to the analytic model may be stored in the decision dependency repository. An analytic model 503 may be linked to the external software product 507 in which it is being modeled. An analytic model has a set of analytic model changes 504 representing the history of the model in the external software. This may include information about each change made to an analytic model as reported by the repository in which it is stored. The decision dependency repository may store only a summary of the change (user, date, time and any notes).

An optimization model object 505 may provide information about a mathematical optimization model represented in external software such as a constraint-based model in a solver or ERP system. Each model may be executed by the external software as a function or service. Optimization models may be fully described only in the external software's repository. An optimization model is linked to the external software product 507 in which it is being modeled. An optimization model 505 also has a set of optimization model changes 506 representing the history of the model in the external software. Information about each change made to an optimization model is reported by the repository in which it is stored. Only a summary of the change (user, date, time and any notes) is stored in the decision dependency repository.

An external software product object 507 provides information about software used to execute a decision making approach as defined using decision logic, analytic models or optimization models. Each piece of software appears once and is linked to all the decision logic, analytic models and optimization models developed using it.

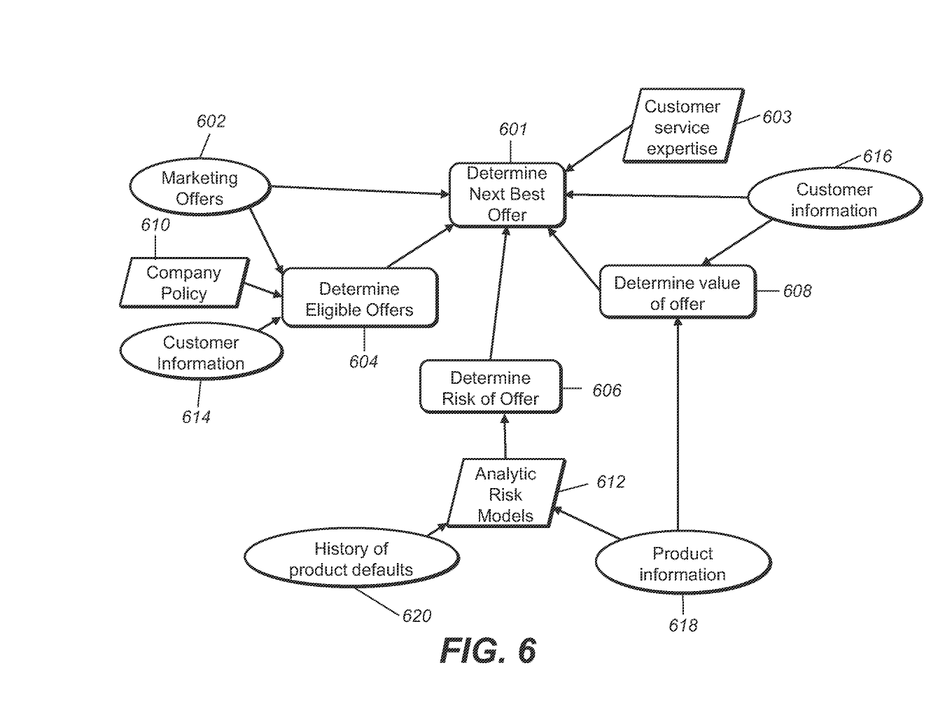

FIG. 6 is an example of a decision dependency model for a “Determine Next Best Offer” decision 601. Such a decision decides what marketing offer or customer service action to suggest to a customer during an interaction. As an example, a typical large bank might make 100,000,000 or more such decisions every month given the number of interactions it has with its customers. This necessitates both automation of the decision process and an understanding of how the bank wants the decision to be made.

FIG. 6 shows that this decision is dependent on three other decisions—determine eligible offers 604, determine risk of offer 606, and determine value of offer 608. Until these three decisions have been made it is not possible to make the determine next best offer decision 601. In other words, it is necessary to determine all of the offers for which a customer is eligible, and then assess the risk of each offer as well as the value of each offer (when applied to that customer) before the next best offer for that customer can be identified.

The figure also shows that the determine eligible offers decision 604 is dependent on knowledge of company policy 610 while the determine risk of offer decision 606 is dependent on knowledge of risk models 612 as represented, for instance, in predictive analytic models, and the overall determine next best offer decision is dependent on knowledge in the form of customer service expertise 603.

Finally FIG. 6 shows the information that must be available for a decision to be made. Customer information 614 and the available marketing offers 602 must be known before it is possible to determine eligible offers 604. This same information 616 is required to make the determine next best offer decision 601, while customer information 616 and product information 618 are required to determine the value of specific offers to a specific customer. The analytic models that predict risk 612 are dependent on the history of product defaults 620 (customers who failed to make payments for credit products on time) and on the product information 618 itself. FIG. 6 thus presents the approach taken to make the decision 601 and allows specification of the core underlying relationships of the decision model.

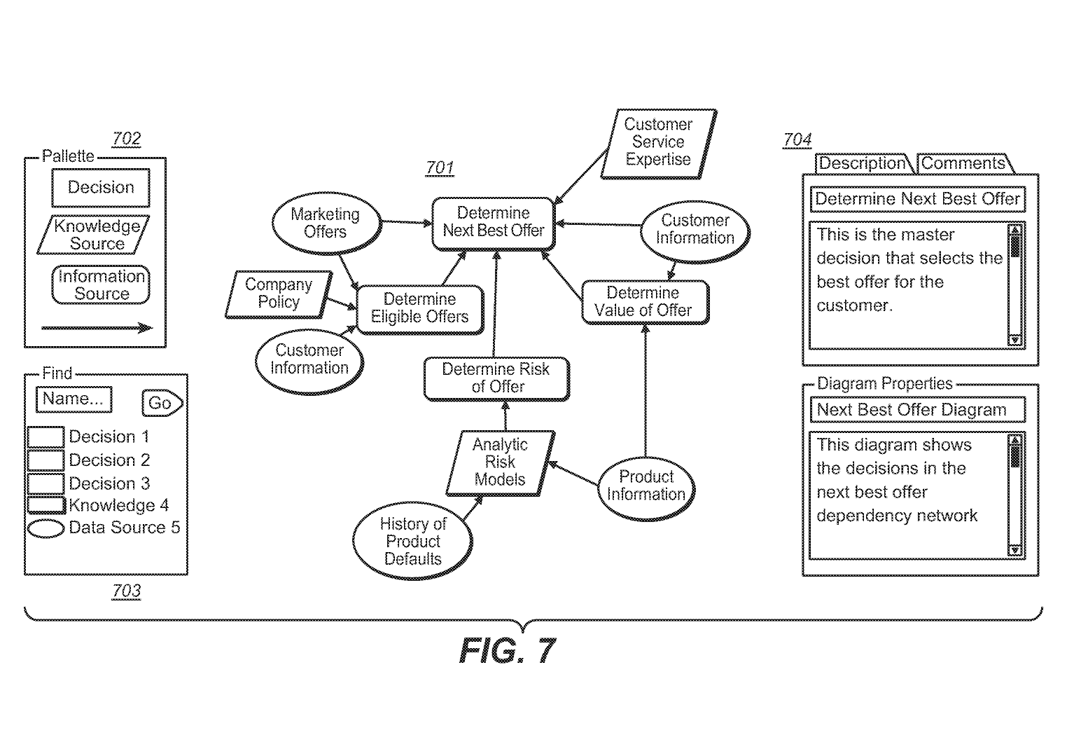

FIG. 7 illustrate a process in accordance with the invention for editing the decision dependency model of FIG. 6. It illustrates how a user can create and delete decisions and graphically link the decisions, information sources and knowledge sources together into a dependency network using a graphical user interface. Comments and update history are shown and a list of collaborators may be derived from this list to support collaboration.

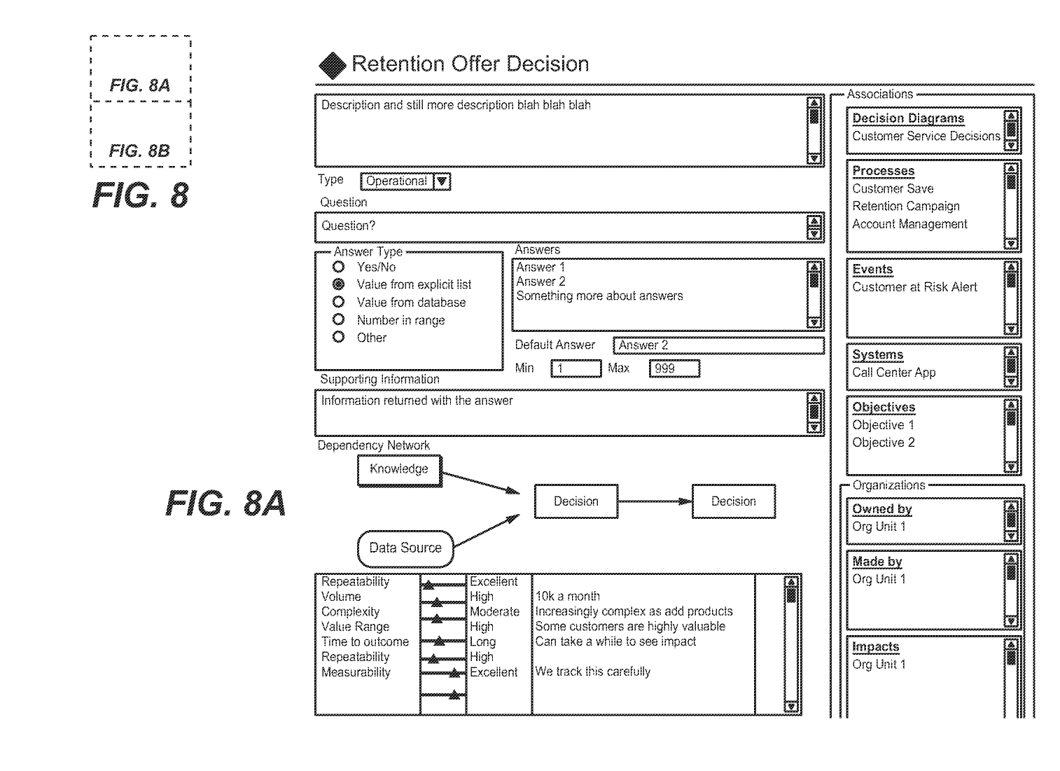

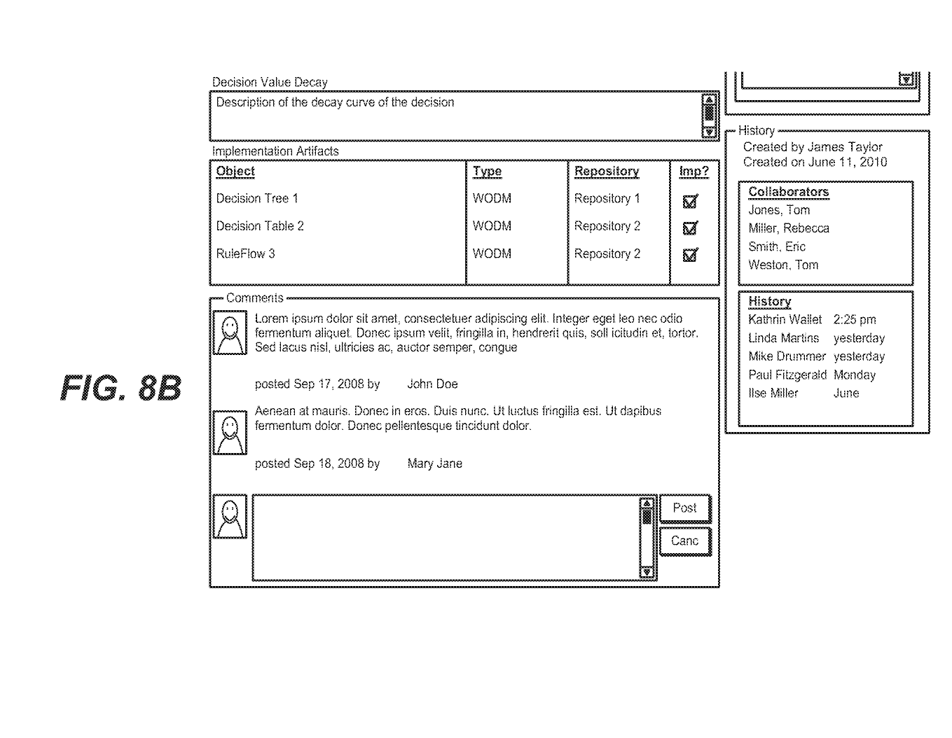

Multiple edit windows with different properties and displays that depend on the kind of object being edited, can be opened to manage the information in the decision dependency repository 102. Users may navigate to other screens within the software such as those shown in more detail in FIG. 8.

FIG. 8, comprising FIGS. 8A and 8B, illustrate an example of a page for editing a decision that allows a user to edit the properties and associations of a decision. The name, description, type, question and allowed answers of the decision can all be specified. The objects on which the decision is dependent or that are dependent on it may be displayed in a dependency network. The volume, complexity, value range, repeatability, measurability and time to outcome as well as the decision value decay can be specified. Comments and update history may be shown and a list of collaborators may be derived from this list to support collaboration. The figure also shows associations to processes, events, systems, objectives and organizations. These may be removed or changed by selecting an indicator, e.g., clicking on an “x” displayed by each, and new associations can be built by searching the repository using the search panel and dragging found objects that are found to the appropriate list. Multiple such edit windows, with different properties and displays depending on the kind of object being edited can be opened to manage the information in the repository.

FIG. 9 is an example of a dashboard 900 being altered by the invention. The dashboard may contain multiple components (such as 901) for displaying information to a user. As will be described in connection with FIG. 13, a dashboard plug-in 104 uses the information in the decision dependency repository 102 to identify those components that are displaying information about an objective or performance measure that have been linked to decision definitions in the decision repository. For each component that is so linked, the dashboard plug-in may display a defined highlight or identifier, such as an arrow 902. The dashboard plug-in may further support interaction with this highlighting, as will be as described in connection with FIG. 12, such that the user can cause the display of a list of linked decisions 903 for a specific software module 901. From this list the user may access the authoring environment to inspect or change the definition a decision, show the dependencies of these decisions or navigate to a decision space.

FIG. 10 is an example of a decision space (1000) in accordance with the invention. The decision space is for the specific decision and objective or performance measure selected to open the decision space (in this example customer retention trends 1001 and determine next best offer highlighted in 1002). A component displaying the objective or performance measure may be automatically included as well as an interactive list of decisions 1002. This shows the list of decisions that impact this objective or performance measure as well as the impact these decisions have on the objective. The dependencies of these decisions can be selectively and recursively displayed.

Depending on the decision highlighted in the decision list 1002, different decision performance software modules are displayed (1003). The time dimension of these components may be automatically aligned with that of the objective or performance measure component. Information about the decision highlighted in the list, such as but not limited to its description, information source or knowledge source dependencies, organizational relationships etc., may be displayed in an additional component 1008. The user can choose to open the authoring environment 101 from this definition also.

A timeline of changes to the implementation of the selected decision is shown at 1004. This timeline uses changes to the implementation of the decision (new or updated rule sets, changed analytic models, etc.) to show every point in the timeline where the decision-making changed. The user can interact with the timeline to display additional information about each change, e.g., the comments made when a new rule set was put into production, or the reasons given by the modeling team for updating a predictive analytic model. This is part of the “why” information needed to understand the basis for decisions.

A list of the implementation artifacts for the decision may also be displayed at 1005, and when one is selected any available edit component for the implementation artifact may be displayed at 1006. Additional links 1007 may be displayed when functionality for interacting with the implementation artifact cannot be embedded as a software module. The implementation details can be edited and updated depending on the security permissions of the user using the standard mechanism provided by the implementation software.

Each decision space may comprise, for example:

An objective or performance measure 1001 displayed in the originally selected component. The component may be essentially repeated from the original dashboard or other user interface;

An interactive list of decisions 1002 that impact that objective that was highlighted on the original decision selected when the decision space display was opened. The user can change the highlighted decision to any other decision that impacts the displayed objective or to one of the decisions on which any of those decisions are dependent (this works recursively down to the lowest level of the decision hierarchy where decisions are not longer dependent on other decisions).

One or more components 1003 linked to the currently highlighted decision based on those listed in the decision dependency repository as reporting on the performance of that decision. The system does not need to know what is displayed on these software modules, only that the user considers it useful for understanding the performance of the decision. Such a component might show the change in decision outcomes over time or the average time to make a decision.

A timeline 1004 showing when the decision was changed. Why a change was made may be derived from version information for implementation artifacts. Any time any linked implementation artifact (such as a rule set, predictive analytic model or report) is updated to a new version, it is reasonable to infer that the decision as a whole is being made differently. The timeline takes all the various changes made and generates a timeline with a marker for each change (several changes made at the same time are considered a single change). The user can interact with this timeline by selecting the markers to see what changes were made and to obtain access to the information recorded about the change in the repository concerned (the notes associated with a new release of a rule set for instance).

The decision space engine may generate a list of implementation artifacts 1005 linked to the currently selected decision from which the user can select. Decision configuration data stored in the decision repository may determine the navigation and the appropriate software module selection generated. This may include but is not limited to links, static information or edit forms that give access to the implementation component concerned. If the implementation component has an edit software module defined in the repository then this may be displayed 1006 by pulling information from the implementation component's repository to populate that edit window using the standard mechanisms defined by that edit software module. The software module may enable editing of the production version of the component, a development or test version of the component or simply a form that requests that someone else make a change to the implementation component. If the implementation component has a display only software module, then this is displayed, similarly pulling the information it needs from the implementation component's repository.

If the implementation component cannot be managed in situ then a link to a system that can manage it may be displayed (1007).

A component 1008 that displays information about the decision that is retrieved from the repository. This might be textual information such as a description, association information such as links to organizational units or graphical information such as a decision dependency diagram. The user can link to additional information about association objects and can open the authoring environment 101 to make changes if desired.

The user may interact with any or all of these components, using in-built interaction and update facilities. All time-based components are preferably overlaid with events recorded in the repository that occurred during the time period displayed. A list of all events for the currently displayed time period may be displayed.

FIG. 11 shows a process for identifying dashboard components with additional information available. It shows how the invention determines which elements on a standard dashboard should be identified as having additional, decision-centric, information available.

The external software displays the dashboard 1100 as usual. The dashboard plug-in of the invention queries the dashboard software to identify the components displayed on the dashboard using the identifiers 1102 for those components common to the dashboard software. This information allows the dashboard plug-in to create a list of all the components currently visible or otherwise available to the user on the current dashboard, page or interface (1104). Using the API to the decision dependency model repository, the invention may query the repository 1106 to see which, if any, of the identifiers found are associated with a widget object in the repository (the widget object may have a field allowing its external identifier to be specified). A list of widgets is assembled 1108. The list represents the widgets described in the repository that are currently available to the dashboard user. For any widget found, the invention queries the repository further to identify and retrieve performance measures and/or objectives are linked to those widgets 1110. If any such performance measures or objectives are found, the repository is further queried to identify and retrieve decisions 1112 that are linked to them in the repository.

The process returns a list of pairs of widget to decision 1114 for each path it finds from widget to performance measure/objective to decision. The dashboard plug-in uses this list to identify each component that is matched to a widget for which there is an entry in this list 1116. The dashboard plug-in changes the way each of these components is displayed 1118 to make it clear to a business user that additional decision-centric information is available.

FIG. 12 shows the steps for displaying additional information in-situ on the user's dashboard. If a user sees a component that has been identified as having additional information (see FIG. 11) they may choose to request this additional information, for instance by clicking on an icon or button or using a context menu 1202. When this is done, the following steps determine what can be displayed.

The user of the dashboard may select an identifier 1204 that is displayed to show that additional information is available. In response, the dashboard plug-in queries the dashboard software 1206 to identify the correct component the user selected for additional information. This identifier may be then used to identify the widget defined in the repository that corresponds to the component 1208. For any widget found, the invention queries the repository further to identify which performance measures and/or objectives are linked to that widget. If any performance measures or objectives are found, the repository is further queried 1210 to identify decisions that are linked to them in the repository 1210. The dependencies of these decisions are then queried to build a complete directed acyclic graph of decisions that impact the performance measure or objective directly or indirectly 1212. Next the repository is queried to retrieve additional information about all decisions identified 1214, such as their descriptions, organizational unit relationships etc., and the assembled information is returned 1216 in a machine readable, structured format such as an XML packet.

The dashboard plug-in may use standard dashboard software features to create and display a new component containing the information 1218. This component allows the decision dependency network to be expanded and collapsed, and additional decision information to be displayed, etc. The dashboard then displays this new component either alongside the original component or as a pop-up component within the overall dashboard environment 1220.

In this way the user of the dashboard sees the list of decisions that have an impact on the information being displayed in the associated component, as shown in the figure. Each decision may be listed along with the impact that it has on the displayed information. The user can interact with this list in a number of ways. For example, the user may select a decision and invoke the authoring environment 101 for that decision so that the authoring environment is started to automatically open and display an editing environment for the selected decision. This allows direct access to the full definition of how the decision is expected to be handled and by whom from within the dashboard. The dashboard plug-in 104 may use the identifier of the selected decision to query the decision dependency repository 102 to see if the decision has other decisions on which it is dependent. If so then this information is returned and the in-situ widget displays those additional decisions in a hierarchical form below the selected decision. This allows the user to see the critical decision-making structure for the decision.

Additional information about a decision such as its description, question/allowed answers information, volume, associated organizational units or other properties/associations of the decision stored in the decision repository may be shown. These properties may be retrieved from the decision repository using the identifier of the decision by the dashboard plug-in, a decision space (see separate description) for the decision may be opened, and the component may be closed. If the user selects additional decision information for another component shown on the dashboard, the content of the in-situ widget will be is updated based on the new component's content.

FIG. 13, comprising FIGS. 13A and 13B, shows the steps for displaying a decision space within the user's dashboard environment. If a user sees a component that has been identified as having additional information (see FIG. 11) they may choose to request this additional information, for instance by clicking on an icon or button or using a context menu. When they do so the following steps may be used to select 1302 what can be displayed. The user determines that they wish to see a decision space to identify a specific decision identified by them in the dashboard interface (1304). The dashboard plug-in queries the component displaying decision information to get the internal identifier of the decision used by the invention. The dashboard plug-in also queries the component displaying information about a performance measure or objective 1306 from which the user opened the decision component (see FIG. 12) to get the internal identifier of the performance measure or objective. The decision space engine then queries the decision repository using the information provided to retrieve various information to be used to populate the decision space 1308. The repository is queried 1310 to find all the widgets defined in the repository that are linked to the performance measure or objective (because they display information tracking the performance measure or showing progress towards the objective). These widgets are added to the list of available widgets for the decision space.

Next, the repository is queried to find all the widgets defined in the repository that are linked to the decision itself 1312 (because they display performance information about the decision). These widgets are added to the list of available widgets for the decision space. The repository is then queried 1314 to determine the decisions in the sub-tree of the selected decision. The decisions on which the decision is dependent are identified and then each of those decisions is queried to find the decisions on which it is dependent. This process is performed iteratively on decisions found until no further decisions are found. Because the completeness and correctness checks (240) include checks to ensure that the decision dependency network is a directed acyclic graph, this will always be true in a valid model and the software checks for invalid models and interrupts processing to ensure it does not get stuck in an infinite loop. The complete list of decisions found is then used to retrieve all the knowledge sources and information sources on which these decisions are dependent (1316). The complete list of decisions found is used to retrieve all implementation artifacts in the repository linked to one or more of those decisions (1318). For each implementation artifact the repository is queried for information on the updates made to those implementation artifacts over time (1320).

The invention may compute the implied change history of the decision 1322 using the update information. The implementation of a decision changes whenever any of the Implementation artifacts linked to the decision or one of the decisions in its sub tree change. The updates made to the linked Implementation Artifacts are assembled in date order along with any notes captured in the repository about the reason for the change and information about the artifact changed. For each implementation artifact the process queries the information available about the external software product (507) linked to information artifact. If the repository contains information on how to generate a link to the editor for the information artifact then such a link is generated 1324. If the repository contains information on how to embed an editor for the information artifact then such embedding code is generated. Any links or embedding code generated are associated with the artifact to which they relate.

The decision space engine determines the initial or default set of items to be displayed from among those identified (1326). This may be controlled by user preferences, by logic in the engine, by priorities stored in the repository, by the items displayed when this decision space was last used or in some other way. These items may be BI components corresponding to the identified widgets, a decision component for displaying information about the decision (including information about its dependencies to other decisions, information sources and knowledge sources), a decision change history component showing a timeline with all the changes made to the decision, components displaying links or embedded editors for Implementation artifacts. The dashboard plug-in takes this information and uses it to create an initial page or interface within the dashboard environment that contains the components that correspond to the selected items (1328). The dashboard software displays the new page or interface so that a business user can interact with the display components (1330). The business user can also change the components being displayed by choosing to view different items from among the possible items found.

Two features of the invention as described above are particularly significant and unique. These are the use of information about decisions and their relationships to alter the behavior of a user interface being used to display data about an organization's performance such as a dashboard (the “dashboard plug-in”) and the use of information about decisions and their relationships to generate a “decision space” user interface.

As explained, the dashboard plug-in (104) element is preferably code that will alter the appearance and behavior of the dashboard user interface (105). The code may query the software interface currently displayed (105), such as a dashboard being displayed in a web browser, for example, to determine what components (115) are being displayed. Each such component is identified with a unique identifier provided by the dashboard or user interface software in use. The software will process each unique identifier in turn. The unique identifier may be used to query the decision repository (102) to identify the widgets defined in the repository that match the unique identifier. For each widget so identified the software may further query the repository to identify the objective or performance measure defined in the repository that links to this widget definition. With the identity of the objective or performance measure being displayed in each component known, the software will further query the repository to identify those decisions that have an impact on the objective or performance measure (information recorded about the decisions, performance measures and objectives in the repository using the authoring environment). The software will create a list of decisions associated with each displayed objective and retrieve information about each decision-objective relationship from the repository.

As described in connection with FIG. 13, this information will be used by the software to identify those components currently displayed for which decision associations are known (for instance by displaying an icon next to these components). This identification will allow the user to select and interact with it (by clicking on an icon for instance). When the user interacts with this identifier, the software will display a list of decisions linked to the selected component's objective or performance measure along with the supporting information retrieved. This list may be displayed in the same user interface being used to display the components, as a pop-up list for instance. The user will be able to interact with the list.

If the user chooses to interact with a decision in the list, the software will further retrieve the decision dependencies for this decision along with other information and will display this interactively in the same user interface, as described in connection with FIG. 12. The user will have a number of options including but not limited to the option to access the authoring environment for a decision in this list, continue to interactively navigate through the decision dependency network defined in the repository or open a decision space (114) from the list.

The software will, thus, fundamentally change and enhance the behavior of the user interface by combining the display of performance data already supported by the user interface with new functions that show the underlying decisions that result in this performance data within the same user interface.

When a user requests a decision space (114) for a particular combination of performance measure/objective and decision, a user interface may be generated programmatically based on information in the repository (102). The software module used to display the objective or performance measure on the original user interface may be placed by the software in a pre-defined location (top left for instance) to provide context for the rest of the user interface. The software retrieves the set of decision information, as described in FIG. 13, and displays a dynamic component that allows interaction with the decisions that impact the objective or performance measure and the decision dependencies of those decisions recursively until there are no further dependencies. This interactive user interface is generated within a software module compatible with the user interface and placed in proximity to the objective's software module. The interactive user interface is set to show the decision information as it was being displayed by the dashboard plug-in (104) when the decision space was requested.

When a decision is highlighted in this interactive component the software accesses the repository, as described in FIG. 13, retrieves the list of associated components relating to decision performance. Various kinds of decision performance can be defined and different components (117) identified for each type of performance for each decision. The software retrieves these software modules and displays user interface components that allow a user to select from the various available software modules. As a component is selected by the user the software uses the existing user interface engine to render the appropriate component in the same user interface. A component showing data that changes over time, such as a component displaying progress toward an objective or a performance measure's value over time, is queried by the software to determine the time period it is currently displaying and the software programmatically drives new components to display the decision performance data for the same period. If the components are interactive, allowing a user to change the time period they display, then the software will detect such changes and keep all components in a single decision space displaying the same time period.

In addition, and as described in FIG. 13, the software may calculate a change history for each decision. Using the information in the repository it identifies the decisions on which the selected decision is dependent and then identifies the decisions those decisions are dependent on and so on recursively until no further dependencies exist. For each identified decision it identifies the implementation artifacts (including but not limited to business rules rule sets in a business rules management system, predictive analytic models, optimization models) linked to the decision in the repository. The change history of each implementation artifacts identified is retrieved using the links to the external repositories (106) that contain these implementation components. This retrieval can also include additional information that describes the change such as a comment made by a user.

A timeline for the period currently displayed in the components may be then derived from this change history with each change to an implementation artifact in the list being an implicit change to the decision making approach being used for that decision. All the changes are assembled into a single list in date/time order. The software generates an additional interactive component that displays this change history for the selected period and that allows the user to interact with the change history to discover, for instance, what change was made to which implementation artifact at each point in the history.

The list of implementation components identified by the software as being relevant to the current decision is used to generate an additional user interface component that allows the user to select one of the implementation components from the list. If an implementation component is selected then the software will retrieve the list of software modules available to view and edit that component from the repository and render those software modules in the user interface using the appropriate rendering engine for that software module. For instance If the user selects a business rules rule set implementation component then the decision space engine would use the business rules management system's engine to render the appropriate editing environment. If the editing environment for the specified implementation component cannot be embedded in the current user interface then a link to its external representation is displayed instead. All software modules displayed to allow editing of the implementation components use those components only update and save logic/functions to update the external repository in which they are generally stored.

As software modules of various types are rendered in the user interface the decision space engine passes through the current user credentials so that each software module can make its own security assessment for the user. This ensures that a user who does not have permission to edit a particular implementation component would see a read-only version of that software module for instance.

As may be appreciated from the foregoing, the invention affords a decision management system and process that affords an in-depth understanding of the factors and sub-decisions involved in business decisions, by gathering together all of the relevant and diverse information that underlie decisions in a decision model, and presenting this information to users so that they can make informed decisions as how and what factors to change to address problems and issues.

While the foregoing may be with respect to particular preferred embodiments of the invention, it will be appreciated by those skilled in the art that changes to these embodiments may be made without departing from the spirit and principles of the invention, the scope of which is defined in the appended claims.

1-20. (canceled)

21. A computer system for performance management in an organization, comprising:
processor;
a first repository coupled to the processor for storing a decision dependency model comprising a plurality of objects that provide information used by the organization to make a decision, said objects comprising one or more of an information source object providing information upon which said decision is dependent, a knowledge source object providing organization information underlying said decision, and a performance measure object providing information on how the organization tracks performance, said objects comprising elements identifying relationships and dependencies among sub-decisions, knowledge and information used to form said decision and that effect said performance measure of the organization;
a second repository coupled to said processor containing definitions and historical performance information about said performance measure;
a dashboard interfaced to the said first repository and to said second repository for presenting to a user on a display of a single decision space historical performance information on the performance measure overlaid on visual information about elements related to said decision that affect the performance measure, the decision space identifying particular elements for which additional information is available and providing direct access to those particular elements for management and change;
an authoring module within said decision space comprising external representation integration instructions for the creation and management of other objects stored in other repositories of other systems, said authoring module comprising executable instructions for controlling said processor to query said first and said second repositories to identify executable objects that are linked to said decision dependency model and to said performance measure and that enable the decision dependency model and supporting executable components thereof to be changed, the authoring module linking to the elements in the first repository that affect said performance measure and enabling said elements in the first repository to be changed to manage said performance; and
an executable code module interfaced to said processor for defining implementation artifacts in the first repository that enable changing of the elements in the first repository.

22. The system of claim 21, wherein said decision space includes components that indicate said relationships and dependencies among the elements of said objects, said decision space synchronizing said components such that a change in information displayed for one element is reflected in a change in corresponding information displayed for other elements.

23. The system of claim 21, wherein the executable instructions of the authoring module comprise instructions that provide a collaborative workflow environment via said dashboard and decision space that enable users of the system to define decisions and relationships among such decisions.

24. A computer implemented method of performance management of an organization using a computer system comprising a processor and first and second repositories, comprising:
storing a decision dependency model in the first repository, the decision dependency model. said decision dependency model comprising a plurality of objects that provide information used by the organization to make a decision, said objects comprising one or more of an information source object providing information upon which said decision is dependent, a knowledge source object providing organization information underlying said decision, and a performance measure object providing information on how the organization tracks performance, said objects comprising elements identifying relationships and dependencies among sub-decisions, knowledge and information used to form said decision, and that impact a performance measure of the organization;
storing in the second repository definitions and historical performance information about said performance measure;
presenting to a user on a dashboard display of a decision space that is interfaced to the first and second repositories historical performance information about the performance measure overlaid on visual information about elements that relate to said decision and that affect the performance measure, the decision space identifying particular elements for which additional information is available and providing access to those particular elements for management and change;
changing the decision dependency model by using an authoring module within said decision space that links to elements in the first repository that affect the decision dependency model and said performance measure, the authoring module controlling said processor to query said first and second repositories to identify executable objects that are linked to said decision dependency model and said performance measure to identify elements that affect said performance measure and that are capable of being changed to manage said performance; and
defining implementation artifacts in the first repository using executable instructions that control said processor to enable changing of the elements in the first repository.

25. The computer implemented method of claim 24, wherein said presenting comprises displaying relationships and dependencies among the elements such that a change in information displayed for one element is reflected in a change in corresponding information displayed for other elements.

26. The computer implemented method of claim 24 further comprising providing a collaborative workflow environment that enables users to define decisions and relationships among decisions using said dashboard.
